(19) United States
(12) Patent Application Publication
(10) Pub. No.: US 2003/0204516 A1
(43) Pub. Date: Oct. 30, 2003

(54) Determination of relevant figures for database recovery processes

(76) Inventors: Jorg Klosterhalfen, Koeln (DE); Holnz-Dlotor Smete, Niederkruchten (DE)

Correspondence Address: BAZERMAN & DRANGEL, P.C., 60 EAST 42ND STREET, SUITE 820, NEW YORK, NY, 10165, US

(21) Appl. No.: 10/414,612

(22) Filed: Apr. 16, 2003

(30) Foreign Application Priority Data
Apr. 24, 2002 (DE) 10218460.7
Nov. 6, 2002 (EP) 02024710.2

(51) Int. Cl. G06F 17/00

(52) U.S. Cl. 707/100

(57) ABSTRACT

The invention relates to a method of determining relevant figures that describe time within a database recovery process, wherein the database comprises at least a multitude of objects and a multitude of log files, wherein the objects are stored in object backups, wherein the database is stored in system backups, in which changes in objects are recorded in log files, and wherein for the purpose of recovering the database in a state at a determinable target point in time objects are reconstructed at least in part from the log files based on the object backups or the system backups. A prediction of the duration of a recovery process can be made in that for a recovery of the database from the system backup the size of the system backup to be retrieved is determined, that for a recovery of the database from the object backups the size of the object backups to be retrieved is determined and that prior to a database recovery the relevant figures are calculated based on the determined sizes and displayed.

### PRIORITY

This application claims priority of German patent application number 102 18 460.7, filed on Apr. 24, 2002 and of European patent application number 02 024 710.2, filed on Nov. 6, 2002, both pending.

### FIELD OF THE INVENTION

The invention relates to a method for the determination of time-defining relevant figures that describe a database recovery process, in which the database comprises at least a multitude of objects and a multitude of data log files, in which the objects are stored in object backups, in which the database is stored in system backups, in which changes in objects are recorded in log files and in which to restore the database to a state at a definable target point in time the objects are reconstructed at least in part from the log files on the basis of the object backups or the system backups.

### BACKGROUND OF THE INVENTION

The backup and recovery of databases is immensely important since errors occur in the operation of databases that possibly may not be able to be remedied at all or only with considerable effort. When running an enterprise software, such as SAP R/3 on an z/OS IBM operating system with a DB2 relational database tens of thousands of objects are created and processed during operation of which approximately ten thousand data objects (table spaces) are used. Other objects may include indexes which store data keys and pointers. All data and tables managed by the database can be termed objects.

A falsification of objects can occur due to program errors, interface errors, and user-originated errors. The falsified objects cause sequence errors in other objects in the database which can only be reconstructed with difficulty. A multitude of falsified objects are produced whose recovery, on the basis of the actual status is only possible at considerable effort and a great risk of error.

When errors occur, the magnetic and/or electrical structures on the storage media and in the memories change. These modified structures must be restored to their original state. The necessary measures must be determined and suitable mechanisms applied to recover and restore the physically correct state.

Since errors are unavoidable, backups of objects, log files, and also of the entire database are performed at regular, determinable intervals.

Data objects are called table spaces. They contain one or more tables and are stored in a physical linear page set logically located (together with other objects) in a database. A data object in the DB2 database from IBM is addressed via Database.Tablespace. Internally, data objects are managed with a database ID (DBID) and a Page Set ID (PSID).

An index only stores the data keys and pointer to the data in a single table. The table is stored in a physical linear page set. An index is always located in the same database as its corresponding data object and has an index space name. Indexes are managed internally with a database ID (DBID) and an index page set (PSID=ISOBID).

The DB2 database also has a multitude of directory tables (approx. 70). Several relevant directory tables are mentioned below. The table SYSIBM.SYSTABLESPACE stores the related pair (DBID, PSID) for a data object Database.Tablespace and can be read by means of Structured Query Language (SQL).

The table SYSBM.SYSINDEXES stores the related pair (DBID, PSID) for an index Database.Indexspace and can be read by means of SQL.

The table SYSIBM.SYSLGRNX stores the relative address RBAs or the sequence numbers LRSNs of object changes under (DBID,PSID). Here, RBAs are used in non-data sharing environments; LRSNs, in contrast, are used in data sharing environments. The table SYSIBM.SYSLGRNX can only be read directly at the physical level (VSAM CI Mode).

Active log files and log file backups (also known as archived logs) with other information (such as consistency points, data sharing definitions, etc.) are managed by DB2 in the bootstrap data set (BSDS). This data set can be printed, read, and analyzed with the standard means available to DB2.

Backup copies can comprise three variations: a full image copy comprising one full object, an incremental image copy comprising only the changes in an object, or a system dump comprising the entire system with all objects. In addition, log files are also written in which the changes in the objects are recorded. Moreover, in the DB2 database, for example, a directory table (e.g., SYSIBM.SYSLGRNX) is written which contains information about the relative byte address (RBA) or the sequence number (LOG Record Sequence Number LRSN) of changes and the objects modified in each case.

The log files are written continually and stored on a data storage device once a certain pre-determined size has been reached, after which they can be newly written. The stored log files can be filed and stored on different storage media, whereby the storage media are selected, for example, depending on the age of the log file backup. A recent log file backup is stored on a fast storage medium, for example, a direct access storage device (hard disk, DASD). Older log file backups, in contrast, may be filed and stored on less expensive, but slower storage media, for example, storage tapes (tape).

It is irrelevant to the database for the time being where an object or a log file is stored. Access to an object or a log file takes place when an access command is issued to the operating system. The operating system is responsible for making the demanded object available. Only the operating system knows whether an object is stored on the original storage medium or has transferred (migrated) to another storage medium. The operating system loads the object and makes it available to the database in which case the duration of the loading process depends on the storage medium and the size of the object.

The objects or also the entire data structure are stored using two different backup methods. On the one hand, there is the option of an online backup (backup at the object level while the database is in operation) in which case, in a backup of this type, the individual objects such as data, indexes (data keys with pointers to data for faster access during data inquiries using keys) and directory structures can be stored. During an online backup, the objects are written onto a storage medium independent of concurrent write/read activities of other processes. It is possible to perform object backups in which case these object backups either store modified objects in their full size (as full image copies) or in an incremental storage (as incremental image copies). In incremental storage, only those changes made in the objects since the last storage or save operation are stored. The invention is not limited to these two storage methods. It is also conceivable that other storage methods are used from which a database can be recovered.

In a so-called offline backup, which is a backup at the storage disk level with the database suspended or stopped, all write processes on the objects are interrupted or terminated and a complete backup of the system is then conducted. This type of a system backup, also called a full dump, contains all objects as well as all log files and can take place on another set of storage disks in the form of a hardware mirroring of the entire system. This means that all data is stored at the same time on a second storage set of devices. These full dumps can generally be performed within a very short period of time.

If an error is detected, it must first be determined at what point in time the error occurred, which makes it possible to pinpoint a target point in time as close as possible prior to the time of the error. This target point in time is expressed in relational databases either by a relative byte address (RBA) or by a sequence number (LOG Record Sequence Number LRSN). Once the target point in time has been determined, the objects must be restored to the state in which they existed at the target point in time. To restore the objects, the database administrator (DBA) can use existing backups and incorporate the changes made in the objects following the backup, which are thus unsaved, using the log files and/or log file backups.

If the database administrator (DBA) wants to recover objects from an online backup, the objects to be recovered must first be defined. The backups can be located on different storage media in which case it is difficult for the database administrator to assess how long this type of a recovery, i.e., the incorporation of changes in the objects, will take.

In the event of an offline backup, the changes from the log files must also be incorporated in the objects, and the database administrator does not know how many objects actually have to be changed. Moreover, the database administrator also does not know how many log files and/or log file backups must be retrieved and read in order to completely reconstruct all object changes.

However, since a recovery process is time critical, it is exceedingly important that the fastest possible method is chosen to recover the objects. It is impossible, however, for the database administrator to determine in advance how much time it will take to recover a database when he proceeds in accordance with one of the two options, which are recovery from online or offline backups.

A disadvantage of known methods is thus that the database administrator has no indication how much time it could take to recover the database. The database administrator has to rely on his experience and make the decision which method to use based on his “gut feelings”. This procedure, however, is regularly faulty, a fact which results in unnecessary downtime for the database.

Accordingly, an object of this invention is the advance determination of the relevant figures related to the time required to recover the database. Further objects and advantages will become apparent from a consideration of the ensuing description and drawings.

### SUMMARY OF THE INVENTION

In accordance with the present invention for a recovery of the database from the system backup the size of the system backup to be retrieved is determined, for a recovery of the database from object backups the size of the object backups to be retrieved is determined, and prior to recovering a database the relevant figures are calculated from the determined sizes and presented.

It has been recognized that, first of all, the size of the backups to be loaded is important in determining the time required to recover a database.

The database administrator is given an idea with the display of the relevant figures in accordance with the invention of how long a recovery of the database could take. This reduces the error probability when choosing the selected method for database recovery.

It is also advantageous and independently considered an invention when the number of objects to be reconstructed is additionally determined. In accordance with a preferred embodiment of the invention it is proposed that the number of objects to be reconstructed based on the object backups or the system backup are essentially determined from the information found in a directory table and that the determined values are also used to calculate the relevant figures. The size of the objects to be reconstructed is also essentially obtained from a directory table. In this connection, for example, the appropriate size can be determined from a reference to an object stored in a directory table via means available to the operating system. Moreover, in the same way, a storage medium or at least a reference to a storage medium can also be obtained from the directory table.

Moreover, according to another preferred embodiment of the invention it is proposed that the number of log files to be retrieved for a recovery of the database is determined by the system backup or the object backups and that the relevant figures can also be determined using these values. This is also independently based on an invention.

In yet another preferred embodiment of the invention the number of log files to be read for the respective recovery method are determined. In the process, the log files can both be active log files as well as log file backups. This is also independently considered an invention. The active log files must simply be read regularly since these files are not migrated, whereas log file backups must be retrieved by the operating system.

Depending on the selected method of recovery, different log files must be used in order to be able to reconstruct the changes in the objects. These change steps can be stored in different log files and their backups so that a different number of log files and their backups must be retrieved and read for the respective recovery methods. During retrieval, the operating system makes a log file available to the database or the recovery process.

The retrieval and reading of log files or their backups also depends on their size. Consequently, according to another preferred embodiment of the invention the sizes are determined for each of the log files and/or log file backups to be retrieved and/or read. The values thus determined are then also used for determination of the relevant figures.

In general, it is important to know how large a log file is. A log file must be processed from start to end in order to incorporate all necessary object changes, thus size is a critical factor. Moreover, the respective log file has to be read in order to be able to determine the changes. The reading in (scanning) of a large log file takes much longer than the scanning of a small log file which is why information about the size of the files is also an important relevant figure.

It often happens that backups are stored on different storage media. For example, current log file backups are stored on fast storage media, such as hard disk storage media, and older log file backups are migrated to slower storage media, such as tape storage media. The operating system performs the migration which ensures that the files can be retrieved and restored. If the active log files and/or the log file backups are stored in each case on at least one storage medium, according to another preferred embodiment of the invention it is proposed that the storage media of the log files and/or log file backups to be retrieved and/or read are determined and that the relevant figures also are determined using these values, which is also inventive in its own right. Since the retrieval or even the reading of log files and their backups can vary in duration depending on respective storage medium, knowledge of the storage media is useful as a relevant figure in determining the time required for a database recovery process. The active log file is frequently stored in memory so that it only has to be read and not first retrieved.

It is also helpful if the number of active log files and/or log file backups to be retrieved and/or read from a directory table is known. The size can also be obtained from a directory table. This embodiment already possesses inventive character in its own right since the readout of a directory table is largely secure and errors can be avoided in determining the relevant figures. A directory table, for example in the DB2 database SYSIBM.SYSLGRNX, contains information about the relative byte address (RBA) or about the sequence number (LOG Record Sequence Number LRSN) of data changes and cannot be read by means of SQL. Reading and analyzing the contents of this directory table makes it possible to determine changes in objects with high certainty, in which case the relevant figures achieve a high degree of accuracy.

When recovering data from an online backup, it is desirable to read and retrieve both full backups (full image copies) as well as incremental backups (incremental image copies) before the subsequent as yet unsaved changes in the objects are incorporated from the log files.

When recovering data from a system backup, it is desirable to retrieve and restore the system backup before the subsequent as yet unsaved changes in the object are incorporated from the log files.

Thus, these two strategies also differ in that the number of objects to be reconstructed varies, which also is significant in terms of time for the recovery processes.

It makes a difference in terms of efficiency and time, whether the data can be recovered from an online backup or from an offline backup because all changes in the objects must be incorporated. Depending on the respective backup strategy, a different number of backups must be retrieved and read, as well as a different number of change steps must be reconstructed.

If full backups (full image copies) are made of essentially all modified objects during an object backup, according to another preferred embodiment of the invention it is proposed that the number and/or size of the full backups to be retrieved and/or to be read is determined and that these values are also used for calculating the relevant figures. If a recovery is conducted based on online backups, the backups of the modified objects must first be loaded by the operating system and made available to the database. The object must then be read, and the change applied to the database to be recovered.

Full image copies are stored both on fast direct access storage devices (DASD), as well as on slower tape storage devices or other storage media whereby the time required to recover a database can be fixed more accurately also by using knowledge about the storage location of the object backups. For this reason, in accordance with another preferred embodiment of the invention it is proposed that the storage media are determined for the full backups to be retrieved and/or read for recovery.

The same applies to incremental object backups, in which case incremental backups (incremental image copies) store changes in objects in determinable intervals. In this case, in accordance with another preferred embodiment of the invention it is proposed that the number and/or size is determined for the incremental backups to be loaded and/or read for recovery and that the relevant figures are also determined using these values. To recover the database, all changes in an object must be incorporated. In the process, the incremental backups are first made available by the operating system and then read. The incremental backups contain information about the changes made in the respective objects. It is useful to know how many incremental backups have to be called and read out in order to be able to reconstruct the changes in the objects.

In this case it is also helpful when the storage media are determined for the incremental backups to be retrieved and/or read for recovery and if the relevant figures are also used to determine these values. The incremental backups contain the respective changes in the objects since their last backup. The incremental backups can also be stored on different storage media, in which case, the age of the incremental backup, for example, is decisive for the operating system in the selection of the storage medium. First, a backup is stored on a fast storage medium and over time this backup is migrated to a slow storage medium since the probability that this type of a backup is required diminishes with the age of the backup. Whether the incremental backups are incorporated depends in terms of time also on the type of storage medium, which is why this value is of interest in the determination of relevant figures.

Indexes are data keys with pointers to data for faster access used in the event of data inquiries via keys. It frequently occurs that the indexes are not included in the backup, but that they have to be rebuilt entirely after the data objects are recovered. It then makes sense if the number of recovered data objects to be read for a reconstruction of the indexes is determined and the relevant figures are determined using these values. When reconstructing an index for a data object, the entire data object is read and the index is automatically rebuilt from this information. Since the recovered data objects must essentially all be read to recover the indexes, it is important to know how many data objects have actually been recovered.

Another subject matter of the invention is the use of the process described above in a relational database, for example DB2 from IBM on a z/OS operating system. In this context, use of the method in accordance with the invention in an enterprise software, for example, SAP R/3 is particularly advantageous.

### BRIEF DESCRIPTION OF THE DRAWING

The FIGURE depicts a flow diagram of a method in accordance with the present invention.

### DETAILED DESCRIPTION OF THE INVENTION

The invention will now be explained in more detail with reference to the FIGURE depicting an exemplary embodiment of the invention.

Step 2 determines whether both online backups as well as an offline backup are available. In an offline backup, the full database is mirrored on another data storage device (full dump), and in the online backups, both full image copies (FIC) and incremental image copies (IIC) are available. If these two backups exist, relevant figures can be determined which define the respective times required to recover the database based on each of these backup methods.

In branch 2a, a relative figure is determined which determines the duration of a recovery of the database based on online backups. Also, step 4 determines the size of the object backups to be loaded by the operating system. Step 8 determines how many FICs and IICs are to be loaded by the operating system and on which storage media the FICs and IICs are stored. Step 10 also determines how many archive logs (log file backups) have to be loaded by the operating system as well as their size and storage location. The values determined using steps 4, 8, and 10 allow for a determination of relative figures which define the duration of a preparation based on an online backup.

Branch 2b determines how long preparation takes for a recovery based on an offline backup. As part of preparation it is necessary that the full backup is retrieved and the archive LOG files are loaded by the operating system. Also, step 12 determines how large a system backup is and on which storage medium it is stored. Step 14 determines how many archive LOGs have to be loaded by the operating system in order to be able to incorporate the changes in the data objects and what size they are. Using these values, a relative figure is determined which defines the duration of the preparation for recovery based on a system backup.

The relevant figures defined in branches 2a and 2b are output 20.

Subsequent hereto, in branch 2c, additional relevant figures are determined which determine the duration of the recovery process for the data objects based on an online backup. Step 22 determines how many FICs have to be read, how large these FICs are and on which storage media they are stored. Step 24 determines for the IICs to be read where they are stored, how large and how many they are. Step 26 determines how many change steps have to be applied from the archive LOG files to the loaded data objects and how large the respective archive LOG files are. Finally, step 28 determines how many changes in active LOG files (active log files) have to be made in data objects, how large the active LOG files are and on which storage medium they have been stored. Based on steps 22, 24, 26, and 28, another relative figure can be defined for determination of a recovery process in terms of time based on an online backup.

Branch 2d determines yet another relative figure which based on a full dump determines a recovery process in terms of time. Step 30 determines how many changes have to be made in data objects based on a system backup from information in archive LOGs. These archive LOGs are determined in their size and their storage medium. Moreover, it is also determined how many changes in data objects must be incorporated from active LOG files, how large the active LOG files are, and on which storage medium they are stored 32. The values determined in steps 30 and 32 make it possible to determine a further relative figure to describe a recovery process. The relevant figures determined in branches 2c and 2d are also output 40.

Finally, relevant figures about indexes can also be determined.

Branch 2e determines how long reconstruction of an index takes, in which case the reconstruction of a single index is accomplished by reading the corresponding data object. In branch 2e, step 42 determines how many data objects have to be read in order to be able to reconstruct the respective indexes.

It is also possible to store the indexes and to recover the individual indexes from the stored indexes. A relative figure is determined in branch 2f for this purpose.

In branch 2g, step 44 determines for an online backup how many index backups have to be read; step 46 determines how many changes in the stored indexes have to be incorporated from archive LOGs, and step 48 determines how many changes have to be reconstructed from an active LOG file in order to recover the indexes.

Branch 2h determines for a system backup how long an index recovery will take. To this end, step 50 determines how many index backups have to be read, step 52 determines how many changes in the read and written indexes have to be incorporated from the archive LOGs, and step 50 determines how many changes have to be incorporated from the active LOG files in order to recover the indexes. The relative figure determined in this way can in turn be output (not shown).

All determined relevant figures for preparation, recovery, and index reconstruction are put together and output 60.

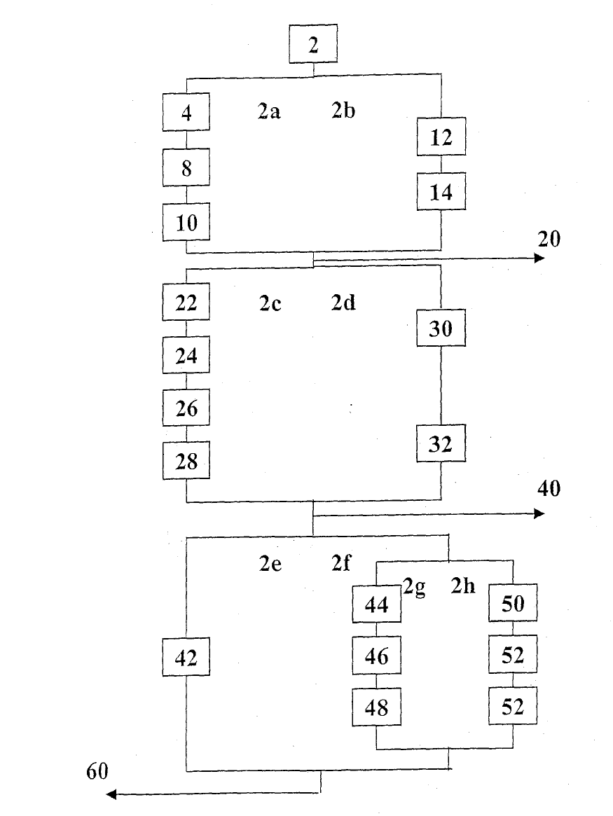

Database administrators are provided with a means by which they can assess in advance on the basis of the output of relevant FIGS. 20, 40, and 60 how long recovery of a database could take. Using these relevant figures, it is more likely that their decision making processes result in the fastest recovery method.

Although the description above contains many specificities, these should not be construed as limiting the scope of the invention but as merely providing illustrations of some of the presently preferred embodiments of this invention. Thus, the scope of the invention should be determined by the appended claims and their legal equivalents rather than by the examples given.

We claim:

1. A method for the determination of relevant figures which describe the time related to a database recovery process,
wherein the database comprises at least a multitude of objects and a multitude of log files;
wherein the objects are stored in object backups;
wherein the database is stored in system backups;
wherein changes in objects are recorded in log files;
wherein in order to recover the database to a state at a determinable target point in time the objects at least in part are reconstructed from log files based on object backups or system backups;
wherein the size of the system backup to be retrieved for a recovery of the database from the system backup is determined;
wherein the size of the object backups to be retrieved for a recovery of the database from the object backups is determined; and
wherein prior to recovery of a database the relevant figures are calculated from the determined sizes and displayed.

2. The method of claim 1, wherein the number, size or storage media of the objects to be reconstructed based on object backups or the system backup are essentially determined from a directory table, and wherein the determined values are additionally used for calculating the relevant figures.

3. The method of claim 1, wherein the number of log files to be retrieved or read for recovery of the database from the system backup or from the object backups is determined, and wherein the relevant figures are additionally determined using these values.

4. The method of claim 1, wherein the sizes of the active log files or log file backups to be retrieved or read for the recovery of the database from the system backup or the object backups are determined, and wherein the relevant figures are additionally determined using these values.

5. The method of claim 1 wherein the active log files or the log file backups in each case are stored on at least one storage medium, that the storage media of the active log files or log file backups to be retrieved or read are determined, and wherein the relevant figures are additionally determined using these values.

6. The method of claim 1, wherein the number or size or storage media of the active log files or log file backups to be retrieved or read are determined from the directory table, and wherein these values are additionally used to calculate the relevant figures.

7. The method of claim 1, wherein in the object backups, full backups of essentially all modified objects are made, that the number or size of the full backups to be retrieved or read for the recovery are determined, and wherein these values are additionally used to calculate the relevant figures.

8. The method of claim 1, wherein the full backups are stored on at least one storage medium, wherein the storage media are determined for the full backups to be retrieved or read for the recovery, and wherein the relevant figures are additionally determined using these values.

9. The method of claim 1, wherein in object backups, incremental backups of changes in objects are conducted, wherein the number or size of the incremental backups to be retrieved or read for the recovery are determined, and wherein the relevant figures are additionally determined using these values.

10. The method of claim 1, wherein the incremental backups are stored on at least one storage medium, wherein the storage media are determined for the incremental backups to be retrieved or read for the recovery, and that the relevant figures are additionally determined using these values.

11. The method of claim 1, wherein the number of recovered objects to be read is determined for a reconstruction of the indexes, and wherein the relevant figures are additionally determined using these values.

12. The method of claim 1, wherein the database is a relational database such as an IBM DB2 database.

13. Use of a method for the determination of relevant figures which describe the time related to a database recovery process,
wherein the database comprises at least a multitude of objects and a multitude of log files;
wherein the objects are stored in object backups;
wherein the database is stored in system backups;
wherein changes in objects are recorded in log files;
wherein in order to recover the database to a state at a determinable target point in time the objects at least in part are reconstructed from log files based on object backups or system backups;
wherein the size of the system backup to be retrieved for a recovery of the database from the system backup is determined;
wherein the size of the object backups to be retrieved for a recovery of the database from the object backups is determined; and
wherein prior to recovery of a database the relevant figures are calculated from the determined sizes and displayed;
in a relational database.
